(19) United States
(12) Patent Application Publication
(10) Pub. No.: US 2018/0265770 A1
(43) Pub. Date: Sep. 20, 2018

(54) COMPRESSIBLE, THREE-DIMENSIONAL PROPPANT ANTI-SETTLING AGENT

(71) Applicant: Baker Hughes, a GE company, LLC, Houston, TX (US)

(72) Inventors: James B. Crews, Willis, TX (US); Naima Bestaoui-Spurr, The Woodlands, TX (US)

(73) Assignee: Baker Hughes, a GE company, LLC, Houston, TX (US)

(21) Appl. No.: 15/921,388

(22) Filed: Mar. 14, 2018

Related U.S. Application Data
(60) Provisional application No. 62/471,435, filed on Mar. 15, 2017.

(51) Int. Cl. C09K 8/80; E21B 43/267

(52) U.S. Cl. CPC C09K 8/80; E21B 43/26; C09K 2208/08; E21B 43/267

(57) ABSTRACT

Compositions for suspending proppants in a hydraulic fracture of a subterranean formation involve a carrier fluid, a plurality of proppants, and a plurality of compressible, three-dimensional anti-settling agents. A method of using the compositions includes hydraulically fracturing the subterranean formation to form fractures in the formation; during and/or after hydraulically fracturing the subterranean formation, introducing proppants into the fractures; during and/or after hydraulically fracturing the subterranean formation, introducing the compressible, three-dimensional anti-settling agents into the fractures where the agents are at least partially compressed before or during the introducing so that they may flow into the fractures. The compressed agents expand after they are in the fractures. The expanded three-dimensional anti-settling agents contact and inhibit or prevent the proppant from settling by gravity within the fractures. The method finally involves closing the fractures against the proppants.

### CROSS-REFERENCE TO RELATED APPLICATIONS

This application claims the benefit of U.S. Provisional Patent Application Ser. No. 62/471,435 filed Mar. 15, 2017, incorporated herein by reference in its entirety.

### TECHNICAL FIELD

The present invention relates to methods and compositions for inhibiting or preventing proppants from settling within a hydraulic fracture formed in a subterranean formation; and more particularly relates to methods and compositions for inhibiting or preventing proppants from settling within a hydraulic fracture, which compositions can be readily pumped into the fracture after which an expansion of compressed, three-dimensional anti-settling agents occurs into a form that enhances interacting with the proppants to inhibit or prevent them from settling.

### TECHNICAL BACKGROUND

Hydraulic fracturing is the fracturing of subterranean rock by a pressurized liquid, which is typically water mixed with a proppant (often sand) and chemicals. The fracturing fluid is injected at high pressure into a wellbore to create, in shale for example, a network of fractures in the deep rock formations to subsequently allow hydrocarbons to migrate to the well. When the hydraulic pressure is removed from the well, the proppants, e.g. sand, aluminum oxide, etc., hold open the fractures. In one non-limiting embodiment chemicals are added to increase the fluid flow and reduce friction to give “slickwater” which may be used as a lower-friction-pressure placement fluid. Alternatively in different non-restricting versions, the viscosity of the fracturing fluid is increased by the addition of polymers, such as crosslinked or uncrosslinked polysaccharides (e.g. guar gum) and/or by the addition of viscoelastic surfactants (VES). The thickened or gelled fluid helps keep the proppants within the fluid while they are placed in the fractures.

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting production of more hydrocarbons as compared with a vertically oriented well that occupies a relatively small amount of the production zone; see FIGS. 1A and 1B. “Laterally” is defined herein as a deviated wellbore away from a more conventional vertical wellbore by directional drilling so that the wellbore can follow the oil-bearing strata that are oriented in non-vertical planes or configuration. In one non-limiting embodiment, a lateral wellbore is any non-vertical wellbore. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. In one non-limiting embodiment, the “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Most fractures have a vertical orientation as shown schematically in FIG. 1A which illustrates a wellbore 10 having with a vertical portion 12 and a lateral portion 14 drilled into a subterranean formation 16. Through hydraulic fracturing a fracture 28 having an upper fracture 18 and a lower fracture 20 have been created where there is fluid communication between upper and lower fractures 18 and 20, and proppant 22 is shown uniformly or homogeneously distributed in the fracturing fluid 24 of the upper and lower fractures 18 and 20. However, over long fracture closure times, and in some non-limiting cases as the viscosity of the fracturing fluid decreases after fracturing treatments, the proppants 22 may settle disproportionately in the lower fracture 20 and the upper fracture 18 may close without proppant 22 to keep it open; thus the operators lose the upper fracture 18 conductivity as schematically illustrated in FIG. 1B. The upper fracture 18 may be the location of the sweet spot horizon 26 of the shale play of the formation 16. The sweet-spot horizon 26 is defined herein as the horizon within the shale interval to be hydraulically fractured that will produce the most hydrocarbon compared to the shale horizons hydraulically fractured directly above and below.

Efforts have been made to make the proppant pack within a fracture more uniform. U.S. Pat. No. 9,010,424 to G. Agrawal, et al. and assigned to Baker Hughes, a GE company, involves disintegrative particles designed to be blended with and pumped with typical proppant materials, e.g. sand, ceramics, bauxite, etc., into the fractures of a subterranean formation to prop them open. With time and/or change in wellbore or environmental conditions, these particles will either disintegrate partially or completely, in non-limiting examples, by contact with downhole fracturing fluid, formation water, or a stimulation fluid such as an acid or brine. Once these particles are disintegrated, the remaining proppant pack within the fractures will lead to greater open space enabling higher conductivity and flow rates. The disintegrative particles may be made by compacting and/or sintering metal powder particles, for instance magnesium or other reactive metal or their alloys. Alternatively, particles coated with compacted and/or sintered nanometer-sized or micrometer sized coatings could also be designed where the coatings disintegrate faster or slower than the core in a changed downhole environment.

Improvements are always needed in the driller's ability to increase and maintain the permeability of a proppant pack within a hydraulic fracture to improve the production of hydrocarbons from the subterranean formation.

### SUMMARY

There is provided in one non-restrictive version, a method of suspending proppants in a hydraulic fracture of a subterranean formation, where the method involves hydraulically fracturing the subterranean formation to form fractures in the formation, introducing proppants into the fractures, introducing a plurality of compressible, three-dimensional anti-settling agents into the fractures where the compressible, three-dimensional anti-settling agents are in an at least partially compressed state. These introducing steps may be performed in any order, simultaneously, or overlapping one another. The next step includes at least partially expanding the at least partially compressed compressible, three-dimensional anti-settling agents to expand and the expanded three-dimensional anti-settling agents, and then contacting and inhibiting or preventing the proppant from settling by gravity within the fractures to the bottom or other lower portions thereof. Finally the method involves closing the fractures against the proppants. In one suitable embodiment of the method, the proppants and the compressible, three-dimensional anti-settling agents are introduced into the fractures at approximately the same time.

There is additionally provided in another non-limiting embodiment, a fluid for suspending proppants in a hydraulic fracture of a subterranean formation, where the fluid includes a carrier fluid, a plurality of compressible, three-dimensional anti-settling agents, and a plurality of proppants.

### BRIEF DESCRIPTION OF THE DRAWINGS

FIG. 1A is a schematic illustration of a wellbore with a fracture having upper and lower portions thereof depicting proppant uniformly distributed in a fracturing fluid in the upper and lower fracture portions, which is under hydraulic pressure to keep it open;

FIG. 1B is a schematic illustration of a wellbore with a fracture having upper and lower portions thereof depicting proppant having settled to the bottom of the lower fracture portion, the upper and lower fracture portions having closed, where the upper fracture is substantially completely closed due to the lack of proppant therein;

FIG. 2A is a schematic illustration of a compressible, three-dimensional anti-settling agent in its expanded or non-compressed state;

FIG. 2B is a schematic illustration of the compressible, three-dimensional anti-settling agent of FIG. 2A in a compressed state;

FIG. 2C is a microphotograph illustrating the compressible, three-dimensional anti-settling agent of FIG. 2A in its expanded or non-compressed state;

FIG. 3A is a schematic illustration of an alternate embodiment of a compressible, three-dimensional anti-settling agent in its expanded or non-compressed state;

FIG. 3B is a schematic illustration of the alternate embodiment of the compressible, three-dimensional anti-settling agent of FIG. 3A in a non-compressed state;

FIG. 4A is a schematic illustration of a different alternate embodiment of a compressible, three-dimensional anti-settling agent in its expanded or non-compressed state supporting, holding, suspending, and/or catching a proppant particle;

FIG. 4B is a schematic illustration of the alternate embodiment of the compressible, three-dimensional anti-settling agent of FIG. 4A in its expanded or non-compressed state;

FIG. 5A is a schematic illustration of an upper fracture where a carrier fluid containing proppants and compressible, three-dimensional anti-settling agents in their compressed states, where the carrier fluid is holding open the upper fracture by hydraulic pressure; and

FIG. 5B is a schematic illustration of the upper fracture of FIG. 5A after the compressible, three-dimensional anti-settling agents have returned to their expanded or non-compressed states to help suspend the proppants to inhibit or prevent them from settling, and the fracture pressure has been released, and where the fracture has closed onto the proppants which hold open the fracture.

It will be appreciated that the drawings are not to scale and that certain features have been exaggerated for illustration or clarity.

### DETAILED DESCRIPTION

It has been discovered that compressible, three-dimensional anti-settling agents having a wide variety of physical shapes and forms may be transported with proppant (or separately) into a hydraulic fracture and used to catch, hold, snag, wedge, suspend, and otherwise engage proppants and temporarily hold them in place within the fracture so that when pumping has been completed and the fracture closes, the fracture faces close against relatively uniformly distributed proppant placement to provide a relatively heterogeneous and uniform improved permeability proppant pack in the fracture.

In another non-limiting embodiment the compressible, three-dimensional anti-settling agents are introduced in a compressed form and change shape and/or size by expanding in volume after they are introduced into the fracture and to configure them to more effectively engage, snarl, catch, suspend, hold or snag the proppants in a relatively homogeneous and uniform distribution prior to fracture closure. When the anti-settling agents are being pumped and introduced into the fractures they are essentially “non-bridging”; that is, they are able to flow to and within the hydraulic fracture. Once the agents expand or “decompress” they can bridge across the fracture singly or collectively bridging the fracture even up to the point of stopping fluid flow due to the collection or agglomeration of agents within the fracture.

The compressible, three-dimensional anti-settling agents should have at least two functions or abilities: (1) they must be transportable with a fluid (defined herein as a liquid or gas) downhole to a subterranean formation, and to and within a hydraulic fracture within the subterranean formation. In this form, it is expected that the compressible, three-dimensional anti-settling agents will be at least partially compressed or entirely compressed, that is, as compressed in size and shape that is practical. They may be part of, contained in, suspended in, dispersed in, and otherwise comprised by the fracturing fluid that fractures the formation. Alternatively they may be introduced subsequently to formation of and/or within the hydraulic fractures in a subsequent fluid. Alternatively, it will be appreciated that the proppants and the compressible, three-dimensional anti-settling agents may be introduced into the fractures at different times or at approximately the same time, or at exactly the same time. Additionally the compressible, three-dimensional anti-settling agents must have (2) the function, design, dimension and/or ability to interact with the fracture face (fractured face of the formation) such as by dragging, skidding, snagging, catching, poking, suspending, wedging or otherwise engaging the sides of the fracture while also snagging, catching, holding, wedging, suspending, supporting, and otherwise engaging the proppant, which is also in the fluid, thereby holding the proppant in place relative to the fracture face to inhibit and/or prevent and/or be a localized support location for the proppant from settling into the lower portion of the fracture by gravity. In one non-limiting embodiment a localized support location is defined to mean as in a concentration distribution of up to every 2 inches (5.1 cm), or up to every 4 inches (10.2 cm), or even up to every 10 inches (25.4 cm) apart from each other. The compressible, three-dimensional anti-settling agents in their expanded or substantially non-compressed configuration, will be localized in positions where proppant that begins to settle will only settle upon them so far until they reach a position where the proppant will come to rest upon them and not settle any further. Thus the anti-settling agents are localized support locations that can vary in distances apart from each other.

The compressible, three-dimensional anti-settling agents are designed and configured to have a geometry and a composition to expand or decompress and interact with fracture walls once treatment is completed, that is, when the treatment pumps are stopped and treatment fluid flow into hydraulic fractures ceases. The functional design of the compressible, three-dimensional anti-settling agents configures them to expand or decompress once they are in place within the fracture and interact with the fracture walls to create distributed support structures within the hydraulic fracture where the anti-settling agent(s) will physically collect settling proppant particles at each anti-settling agent locale, or at least a majority (greater than 50%) of such locales. In one non-limiting embodiment, anti-settling agents in this case means many distributed anti-settling agents configured to act as support structures, where “support structure” means a physical object to obstruct, prevent, restrict, and otherwise control proppant from sedimentation to the bottom of the hydraulic fracture by gravity. In one non-limiting embodiment the fractures are oriented vertically, or to a vertical degree i.e. where proppant settling by gravity is undesirable.

It will be appreciated that it is not necessary for the compressible, three-dimensional anti-settling agents to hold the proppant fast to the fracture face in the sense of adhering it or fixing it in place. When the fracture closes on the proppant, that is the force and process that holds the proppant in a fixed place and location. The anti-settling agents only need to catch, snag, hold, suspend, and/or support the proppants sufficiently to inhibit or prevent them from settling by gravity. It is acceptable if the anti-settling agents hold the proppants permanently or securely to the fracture face, but it is not necessary because it is expected that as the fracture closes and the space between the opposing fracture walls narrows the proppants may be moved slightly into their permanent places under closure pressure. In other words, the proppants may be temporary suspended for a short time before the fracture closes. This time is long enough for inhibiting or preventing the motion of proppant with anti-settling agent downward to the bottom of the fracture. Thus, the anti-settling agents must be transportable in a treatment fluid, but also have a physical shape or combination with physical property that interacts with the formation face (drag, skid, snag, catch, poke, wedge, etc.), and/or interaction in a fracture network, such as at complex fracture junctions, narrowings of hydraulic fracture, and of course the ultimate property of residing or fixating in the fracture locales once treatment pumping has been completed and be functional by design and physical properties to suspend proppant particles.

It should also be appreciated that while one anti-settling agent may be very capable of holding one proppant in place that it is expected that multiple anti-settling agents will also catch, snag, collect, and otherwise engage with one another to support and catch one or more proppant(s) to inhibit and/or prevent the proppant from settling due to gravity.

In one simple non-limiting embodiment the compressible, three-dimensional anti-settling agent comprise a single compressible component and/or a plurality of connected components or pieces. In one non-limiting embodiment, the anti-settling agents may be or resemble tiny sponges and thus may be considered to comprise a single compressible component. In an alternate non-limiting embodiment, the anti-settling agents may have multiple components, in a non-restrictive version a sandwich-like structure e.g. two different planes connected by one or more filaments. Alternatively the planes may be comprised of a plurality of filaments.

A “filament” is defined herein as a slender threadlike object or fiber, including but not necessarily synthetic or polymer monofilament, braided filaments, continuous filaments, or natural filaments found in animal or plant structures. The pieces and/or filaments may be the same as or different from one another and the filaments may of the same or different sizes, diameters, lengths, and/or widths. In one non-limiting embodiment the filament diameter may range from about 0.001 inch (25 microns) independently to about 0.1 in (0.25 cm), alternatively from about 0.005 (127 microns) independently to about 0.05 in (1.3 mm); in another non limiting embodiment, the filament diameter may range up to 5 mesh (4 mm). The plurality of filaments may involve a structure including, but not necessarily limited to, woven, non-woven, knitted, laminated, plied, spun, knotted, stacked, and combinations thereof. A “non-woven” plurality of filaments are where the filaments are not woven together but are nevertheless interconnected in a way that the filaments do not separate. Thus, there is a wide variety of configurations in which the filaments may be connected. It will be appreciated that while the anti-settling agents may be at least initially configured to have a generally flat structure and/or small cross-sectional profile to permit them to be pumped downhole to be introduced into hydraulic fractures, they will have, or optionally undergo a shape change to have, a relatively larger three-dimensional (3D) structure as well configured to connect with and engage each other, the fracture face(s), and proppant(s). By “relatively larger” is meant that the expanded or decompressed configuration or volume is larger than the compressed configuration or volume of the anti-settling agents. It will be appreciated that the methods described herein will work even if the agents are not fully compressed during transport and are not fully expanded when they serve to support and suspend the proppants in the fractures.

The components of the compressible, three-dimensional anti-settling agent may come from a wide variety of sources and materials including, but not necessarily limited to, straw, wool, cotton, paper, threads, elastic polymers, and combinations of these. In an optional embodiment, the anti-settling agents may be recycled and reused from these and other sources.

The anti-settling agents may be composed of any suitable materials and/or filaments, conventional or to be developed, including, but not necessary limited to, cotton, wool, silk, fiberglass, polyester, polyurethane, aramid, acrylic, nylon, polyethylene, polypropylene, polyamide, cellulose, polylactide, polyethylene terephthalate, rayon, metal foams, ceramic foams, polyvinyl alcohol, other synthetic filaments and the like, and combinations thereof. Filament properties to be considered include elasticity, ductility, softness, density, diameter, length, stiffness, surface roughness, linear character (straight, curled, kinked, etc.), solubility, glass transition temperature, melt temperature, softening temperature, flexibility with heating, etc. Downhole temperatures may vary from about 38° C. to about 205° C., in one non-limiting embodiment, and thus the anti-settling agents need to function at these temperatures. Other characteristics and properties to consider include, but are not necessarily limited to, stiffness, density, denier, weave, thread count, geometric design and structure (e.g. cloth, netting, etc.), longevity in the expected hydraulic fracture conditions, solubility, combinations of different threads (comingled threads, etc.), dispersibilty (in water, salt water, etc.), transportability (in polymer-viscosified fluid, in viscoelastic surfactant-viscosified fluids, and in non-viscous (water and slickwater) treatment fluids), whether the materials in the anti-settling agents can be crosslinkable to the treatment fluid polymers like guar (including the amount and degree of crosslinkable sites on select filament strands composing the anti-settling agent), whether the anti-settling agents are hydrophilic or hydrophobic, and combinations of these. In another non-limiting embodiment the quantity of filaments or other components per unit of area (e.g. inch² or cm²) will affect flexibility and compressibility. Specifically, the greater the quantity the less flexible.

In one non-restrictive version, the anti-settling agents have a moderately high flex or degree of stiffness to bend. In a non-limiting example, in relation to common fishing line, monofilaments (non-braided) may range in strength from 2 independently to 200 lbs test line (8.9 to 890 N/m); alternatively from 4 independently to 80 lbs test line (18 to 356 N/m).

As mentioned, the compressible, three-dimensional anti-settling agents change shape once they are placed within the hydraulic fracture. In one non-restrictive example, the anti-settling agents are introduced in fully or at least partially compressed form and then permitted to expand or decompress to a spatially larger form which may or may not be their fully expanded or uncompressed form. In a non-limiting embodiment the compression may be done at a lower temperature and the expansion may occur at a higher temperature within the fracture over an effective period of time, depending on the thermal properties of the agents to enlarge or expand when heated, or otherwise change shape. Such a phenomenon may change the anti-settling agents from having a generally flat shape or compressed conformation to a 3D shape, which permits them to engage and/or connect with the fracture faces, each other, and particularly the proppants more readily as compared to their initial flat shapes. In another non-limiting embodiment the anti-settling agents may be a shape memory polymer which has one shape, such as a linear or flat shape when it is pumped downhole and introduced into the fractures, and then triggered to have a more 3D different shape, such as curled, spiral, zig-zag, volume increase, and the like. In one non-limiting embodiment, the three-dimensional anti-settling agents are elastic and may be in a compressed state when introduced into a fracture and then slowly expand or restore to their non-compressed state on their own, such as is the case with shape memory materials. External stimuli to trigger shape change of a shape memory polymer (SMP) include, but are not necessarily limited to, temperature change; absorbing fluids and swelling, dissolution in water (including solubility in treatment brine and formation brine) of a portion, thread(s), film(s) or component(s) of 3D anti-settling agent; an electric field; a magnetic field; a solvent or fluid; presence of mono- and disaccharides; presence of polyenoic acids; application of a stress or force, change in magnetic field, change in electrical field, changes in pH of the fluid surrounding the anti-settling agents, actuation, by dissolving, by hydrolyzing, and combinations thereof. In one non-limiting embodiment, actuation may be defined as a change in a property including, but not necessarily limited to, a change in the shape or thickness that occurs if a force is applied, such as a magnetic field or an electrical field. An electrical field includes electron movement (e.g. static electricity). A magnetic field includes, but is not limited to, spin of the electron (e.g. a permanent magnet). An electromagnetic field is a specific case where the two field types interact with one another, in this case the two fields are at 90° to each other; a moving charge would be a non-limiting example. Suitable shape change polymers include, but are not necessarily limited to, polyester, polycarbonate, polyurethanes, nylon, polyamides, polyimides, polymethyl methacrylate, polyureas, polyvinyl alcohols, vinyl alcohol-vinyl ester copolymers, phenolic polymers, polybenzimidazoles, polyethylene oxide/acrylic acid/methacrylic acid copolymers crosslinked with N,N′-methylene-bis-acrylamide, polyethylene oxide/methacrylic acid/N-vinyl-2-pyrrolidone copolymers crosslinked with ethylene glycol dimethacrylate, polyethylene oxide/poly(methyl methacrylate), N-vinyl-2-pyrrolidone copolymers crosslinked with ethylene glycol dimethacrylate, and combinations thereof. In summary and in a non-restrictive version, the compressible, three-dimensional anti-settling agents are configured to change shape where the anti-settling agents have a first shape and a subsequent shape and the method further comprises introducing the anti-settling agents into the fractures when the agents have a first shape, and the agents change shape after a period of time within the fractures to the second shape.

In another non-limiting embodiment at least a portion of each anti-settling agent is hydrolyzable before or after the inhibiting or preventing the proppant from settling. “Hydrolyzable” as defined herein is synonymous with dissolvable or otherwise breaking down upon contact with water; this includes decomposing in the presence of water under acidic or basic conditions. Generally, it is expected that the hydrolysis will be achieved by water alone, which includes water and the temperature necessary for overcoming the activation energy required for hydrolysis. Hydrolysis may also be accomplished by water having an acidic or alkaline agent in water in a proportion suitable and/or a pH suitable to dissolve or decompose part or all of the agents. “Decompose” is defined herein to mean that the disintegration may not generate water soluble chemicals; that is, there may be insoluble portions or pieces remaining. It should be appreciated that the agents and/or components thereof do not need to be hydrolyzable or dissolvable, but may be from common, relatively inexpensive materials that may decompose very slowly, such as over the course of many years, or less time. Suitable hydrolysable materials include, but are not necessarily limited to, polyvinyl alcohols (PVOH), polylactic acids (PLA), polyglycolic acid (PGA), polyethylene terephthalate (PET), polyesters, polyamides, polycarbonates, and combinations thereof, that at least partially dissolve in water. These materials will be discussed in further detail below.

In one non-limiting embodiment at least a portion of the anti-settling agents introduced into the fractures is hydrolyzable, meaning that of multiple types of anti-settling agents introduced, some agents are hydrolyzable, or relatively more hydrolyzable than others. Alternatively, or additionally, in another non-restrictive version, at least a portion of each agent is hydrolyzable.

In a different non-limiting version the compressible, three-dimensional anti-settling agent may have two or more layers or laminations. Suitable layers or laminations include, but are not necessarily limited to, layers with two or more sheets with different dissolution rates, which may include plastic, woven, and/or non-woven sheets, mesh or net. In a non-limiting example, a netting composed of polyester threads that is manufactured between polyvinyl alcohol (PVOH) sheets or films, where during the fracture treatment the PVOH sheets dissolve during heating of the treatment fluid under downhole reservoir conditions to release the polyester netting, optionally including a means to make the netting more flowable during addition to treatment fluid mixing, and more pumpable to downhole reservoir. In another non-limiting embodiment, for instance a constraint such as a thin hydrolyzable coating that dissolves over time or temperature and is no longer substantially present after a time within the fracture may release or permit one or more components of the agents to expand or decompress to thus be configured to engage the proppants to prevent or inhibit them from settling. The same principle can be used for agents laminated where select sheets or portions dissolve to release a 3D shape, including, but not limited to, a “sandwich”, a coil, a hook, a spiral, a branch, a sphere, a cube, etc. and combinations thereof.

At its basic form, a “sandwich-shaped” anti-settling agent may comprise at least one first layer and at least one second layer where the layers are permanently connected, such as with a plurality of filaments, and the method further comprises introducing the agents into a fracture in compressed or non-expanded form, and a change occurs due to a change in temperature, chemical composition, dissolution of at least a portion of one of the agents, change in pH, contact with a chemical that functions as a solvent, a slow release acid or basic particle, and a combination thereof so that when at least a portion of the agent changes, for instance is hydrolyzed, the remaining agent changes shape and expands, enlarges and/or decompresses.

With respect to the dimensions of the agents, it will be understood that the fractures each have at least two opposing fracture walls across a gap and where the agent singly has at least one dimension that spans the gap between the opposing fracture walls or where multiple agents interconnected or entangled with one another spans the gap between the opposing fracture walls. In one non-limiting embodiment the agents in their expanded or non-compressed configuration comprise an average length of from about 0.02 inch (about 0.5 mm) independently to about 0.5 inches (13 mm); from about 1 inch independently to about 20 inches (about 2.5 to about 51 cm), alternatively from about 1.5 inch independently to about 15 inches (about 3.8 to about 38 cm), and in another non-limiting embodiment from about 2 inch independently to about 12 inches (about 5.1 to about 31 cm). The term “independently” as used with respect to a range means that any threshold may be combined with any other threshold to give a suitable alternate range. As an example, a suitable alternative average agent length range would be from about 0.02 inch to about 1 inches (about 0.5 mm to about 2.5 cm).

The agents in non-compressed configuration may have an average width of from about 0.02 inch independently to about 8 inch (about 0.5 mm to about 20 cm), alternatively from about 0.1 inch independently to about 4 inch (about 2.5 mm to about 10 cm), and in another non-limiting embodiment from about 0.2 inch independently to about 2 inch (about 5 mm to about 5.1 cm); alternatively the lower threshold may be 0.05 inch (1.3 mm). The agents in non-compressed configuration may have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm).

In one non-limiting embodiment a minimum aspect ratio is about 1 inch (2.5 cm) long by 0.2 inch (0.5 cm) tall by 0.1 inch (0.25 cm) thick or 5 to 1 to 0.5, in non-compressed configuration, although other aspect ratios are acceptable.

In another non-restrictive version the anti-settling agents may have barbs or extensions therefrom. These barbs or extensions extend outward from the agent, in a first embodiment within a 3D sandwich thickness, in a second embodiment as extensions along the plane of the layers of the “sandwich”. In other non-limiting versions the “sandwich” may have a 3 mm thickness with 2 mm barbs and/or monofilament thicker in width to make the sandwich 3 mm+2 mm or a total of 5 mm thick in width within the hydraulic fracture, where the total ranges from 0.02 mm independently to 12 mm; alternatively ranges from 0.05 mm independently to 8 mm. In one version the extension barbs and/or mono-filaments may range from 0.02 mm independently to 56 mm long; alternatively from 0.05 mm independently to 25 mm long. It is expected in one non-limiting embodiment that the barbs and/or monofilaments will be more flexible for the longer specified lengths and relatively more stiff for the smaller lengths. A barb or extension occurs where two or more filaments are in some way connected, including but not necessarily limited to glue, thermally fused, twisted together, knotted, etc.). Monofilament may include simple fishing line filaments, or natural and synthetic single or mono-fibers.

The loading or proportion of the anti-settling agents in the treatment fluid, fracturing fluid or other carrier fluid, which may be water or brine, range from about 0.1 pounds per thousand gallons (pptg) independently to about 200 pptg (about 0.01 to about 24 kg/m³); from about 0.2 pptg independently to about 100 pptg (about 0.02 to about 12 kg/m³); from about 0.5 pptg independently to about 50 pptg (about 0.06 to about 6 kg/m³). Alternative upper thresholds include about 40 pptg (about 4.8 kg/m³) and about 20 pptg (about 2.4 kg/m³).

When the carrier fluid is a high viscosity fluid, its viscosity may range from about 15 independently to about 60 pptg (1.8 to about 7.8 kg/m³) polymer fracturing fluid or equivalent; alternatively from about 20 independently to about 40 pptg (about 2.4 to about 4.8 kg/m³) in a non-restrictive example as a borate crosslinked polymer fracturing fluid or equivalent. In one non-limiting embodiment, the polymer to increase the viscosity of the carrier fluid is a polysaccharide, which includes, but is not necessarily limited to, guar, carboxymethylcellulose (CMC), and the like. Other crosslinkers may be used besides borate, including, but not necessarily limited to, zirconium. Viscoelastic surfactants (VESs) may also be used to increase the viscosity of the carrier fluid. In this context, in one non-limiting embodiment, if the anti-settling agents are without barbs or monofilament widths or extensions, they may have a width from about 0.5 mm independently to about 4 mm, a height from about 3 mm independently to about 50 mm, and a length from about 20 mm independently to about 200 mm. Alternatively, with barbs or monofilament widths or extensions they may have a width from about 0.8 independently to about 12 mm, a height from about 8 mm independently to about 40 mm, and a length from about 30 mm independently to about 100 mm.

In one non-limiting embodiment the 3D density of filaments per volume and filament structure of the anti-settling agents, in a non-limiting example, mesh sides or top and bottom with low density filaments interconnecting the sides (or interconnecting the top and bottom) will allow the carrier fluid, e.g. guar treatment fluid, to enter the void area inside the 3D agent, and once the crosslinking occurs, the 3D agent become part of the treatment fluid. That is, the 3D anti-settling agents will have active sites which will be chemically connected or “crosslinked” to the polymers and/or VESs of the carrier fluid. Thus, the anti-settling agents can transport more easily than if they were dense and very little crosslinked fluid was within the 3D anti-settling agents. By having fluid inside the agents, which fluid that is associated with the fluid outside the agents, then in concept as the anti-settling agents encounter transport resistance (like against wall of hydraulic fracture), the anti-settling agents will be less likely to slow down or even stop since it will it tangibly part of the treatment fluid and unitized by crosslinked (or otherwise viscosified) fluid acting as a mass, and by comparison not a water treatment fluid with a 3D filament agent transported along by water.

The description directly above describes in part how with the anti-settling agent being intimately mixed with crosslinked fracturing fluid will transport with the fluid. Where the crosslinked fluid goes, the 3D anti-settling agents combined with the crosslinked fluid will have high viscosity mass empowering the 3D unit to flow and stay as a unitized mass, for instance like a crosslinked fluid encountering the wall of the hydraulic fracture does. The characteristic of the fluid as being “non-slip” is then related to the anti-settling agents being as one unit with the crosslinked fluid, such as when the 3D structure hits, brushes, or otherwise contacts the hydraulic fracture wall, which in some regions of the hydraulic fracture (i.e. in most cases farther from the wellbore) as the widths of anti-settling agents encounter like widths of the hydraulic fracture, then the “unitized flow” property of the treatment fluid-3D anti-settling agents will start to compress the inner filaments of the sandwich structure to become less wide and thereby still flow or transport with and where crosslinked treatment fluid continues to go. Because the agents are three-dimensional means it has more flow-ability as a treatment fluid as compared with a simple piece of fabric (like a small wedge of cotton cloth transported in a treatment fluid that meets a restriction of some type).

The present invention will be explained in further detail in the following non-limiting examples that are provided only to additionally illustrate the invention but not narrow the scope thereof.

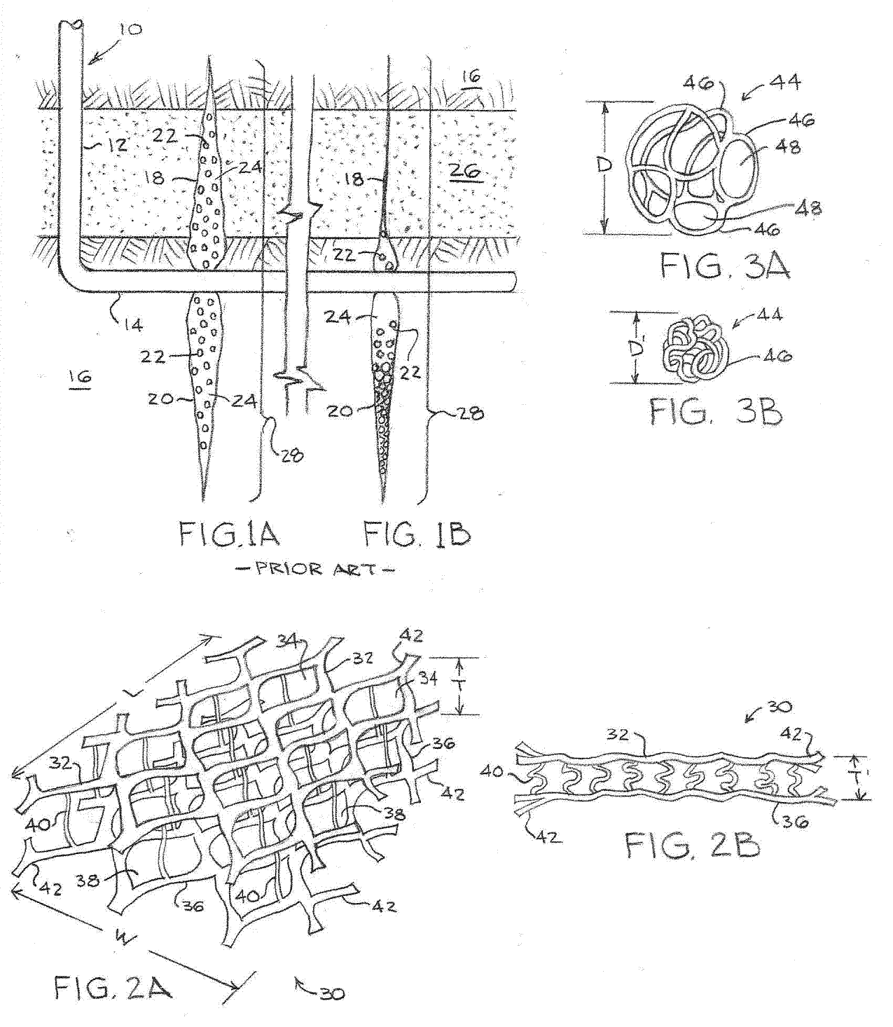

Shown in FIG. 2 is a schematic representation of one non-limiting embodiment of a compressible, three-dimensional anti-settling agent 30 having a length L and a width W and a thickness T viewed in a three-quarters or perspective orientation and composed of a first layer 32 comprising a plurality of openings 34 and a second layer 36 additionally and similarly comprising a series of openings 38. Openings 34 and 38 are shown in FIG. 2A to be of a generally uniform size and shape, but this is optional and not critical. That is, openings 34 and 38 may be of different sizes or shape from each other. The openings 34 and 38 should, however, generally be sized to be smaller than the average particle size of the proppant to be suspended or retained so that the proppants generally do not pass through the agent 30.

First layer 32 and second layer 36 are connected by a plurality of filaments 40. It will be appreciated that filaments 40 may be made of the same or different material as first layer 32 and second layer 36. First layer 32 and second layer 36 may have a plurality of barbs, tips, spines, spurs or spikes 42 extending therefrom, which barbs 42 may eventually engage the fracture faces and/or proppants. The barbs 42 may simply be cut ends of the layers 32 and 36 that extend outward from the agents 30. Shown in FIG. 2C is microphotograph of a commercially available polymeric material that has a “sandwich-type” structure such as that shown in FIGS. 2A and 2B showing two layers connected by a plurality of filaments.

Shown in FIG. 2B is a side view of the anti-settling agent 30 of FIG. 2A after compression in the vertical direction, that is, in the direction of the thickness

T of the agent 30, where the compressed thickness T′ is less than the original or uncompressed thickness T. Thus, in the non-limiting embodiment of anti-settling agent 30, the compressed anti-settling agents having compressed thickness T′ of FIG. 2B would be pumped with the fracturing fluid and proppants into a hydraulic fracture and then be expanded fully or at least partially to the thickness T of FIG. 2A.

As will be appreciated, the embodiments in FIGS. 2A, 2B, and 2C have denser outside or “bread” layers 32 and 36, where the “filling” or inside of the filaments 40 is less dense. In general, low filament count, maybe 10 or even 4 filaments per unit area, for instance from 50 independently to 2 filaments per inch (about 20 to about 1 per cm), alternatively 25 independently to 4 filaments per inch (about 10 to about 2 per cm), may be used.

Shown in FIG. 3A is an alternate embodiment of compressible, three-dimensional anti-settling agent 44 having a looped, filamentous structure of a plurality of fiber loops 46 with a plurality of openings 48 therein. Three-dimensional anti-settling agent 44 of FIG. 3A is in its non-compressed or expanded form, and has a generally spherical shape of average diameter D. One way of understanding anti-settling agent 44 is as “sponge-like” where the openings or holes 48 are relatively large compared to the overall body of the agent 44. Again openings or holes 48 should be designed to be relatively smaller than the average particle size of the proppant so that the proppant is inhibited from passing through the agent 44 and thus held or suspended in place in the hydraulic fracture. Fiber loops 46 and openings 48 may or may not be uniform or symmetrical. In the embodiment shown in FIGS. 3A and 3B, they are not uniform or symmetrical.

Shown in FIG. 3B is the three-dimensional anti-settling agent 44 of FIG. 3A in a compressed configuration having a smaller average dimension D′ than expanded average dimension D. Because compressed anti-settling agent 44 also has a generally spherical shape, it should be readily pumped downhole with the hydraulic fracturing fluid into the fracture, in one non-restrictive version.

Shown in FIG. 4A is another, different non-restrictive embodiment of a compressible, three-dimensional anti-settling agent 50 having a six-sided cube shape, composed of 12 edges 52, each edge 52 generally having a dimension E and six square openings 54 having an area of about A=E². The area A should be dimensioned to be smaller than the average particle size of a proppant 56 so that most of the proppants 56 cannot pass through the openings 54 when the agent 50 is in its fully expanded form.

Shown in FIG. 4B is a compressed form of the three-dimensional anti-settling agent 50 of FIG. 4A in compressed form having an average largest dimension of E′ which is less than that of E. It is anticipated that compressing agent 50 will give a roughly compressed shape that can be readily pumped with the carrier fluid (e.g. hydraulic fracturing fluid) into a fracture in a subterranean formation.

It will be appreciated that the three-dimensional anti-settling agents are not limited to the shapes depicted in FIGS. 2A, 2B, 2C, 3A, 3B, 4A, and 4B, and that a wide variety of suitable shapes and designs may be imagined including, but not necessarily limited to, cones, pyramids, columns, tetrahedrons, octahedrons, dodecahedrons, and the like.

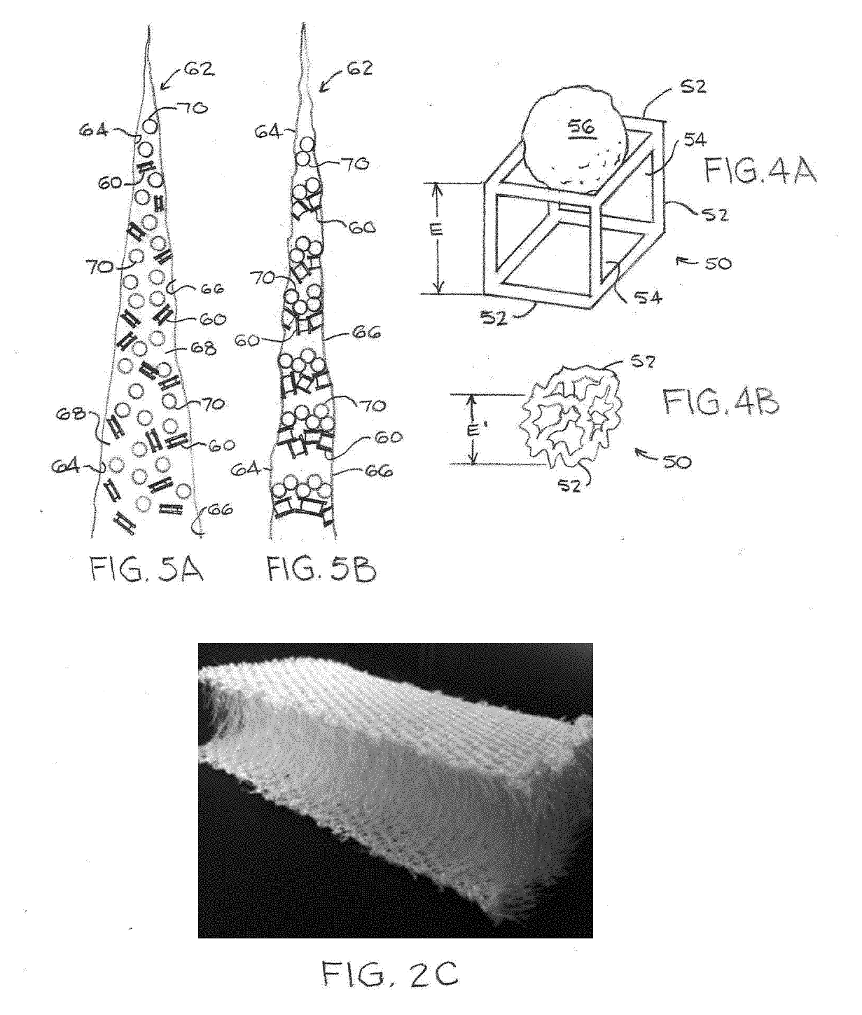

In operation, as schematically shown in FIG. 5A, a plurality of compressed, three-dimensional anti-settling agents 60 are introduced into a hydraulic fracture 62 along with proppants 70 in a generally uniform dispersion in a treatment fluid 68, which in one non-limiting embodiment may be a brine-based fracturing fluid. The fracture 62 has a first fracture face 64 and an opposing, second fracture face 66. As the pumping pressure eases or is removed, fracture faces 64 and 66 collapse toward each other (see FIG. 5B) and agents 60 and proppants 70 are urged toward each other in a reduced volume. Agents 60 expand in size and shape to that schematically illustrated in FIG. 5B, and singly and in groups bridge the gap between faces 64 and 66 and catch, grab, ensnare, and otherwise inhibit and prevent proppants 70 from settling by gravity and thus proppants 70 keep and prop the fracture 62 open after the pressure is completely released and the fracture 62 closes as much as possible, but for the presence of the proppants 70, as schematically illustrated in FIG. 5B. It will be appreciated that a single, at least partially expanded agent 60 may hold, suspend, or otherwise fixate one or more proppant particles 70. It will be additionally appreciated that introducing the agents 60 into the fractures 62 can comprise a carrier or treatment fluid 68 where a proportion of agents 60 in the carrier fluid act to interconnect other multiple individual agents 60 into larger connected lengths or a plurality of variable shapes, and which can range in concentration from about 0.01 pptg to about 20 pptg (about 0.001 to about 2.4 kg/m³). It will be further appreciated that the sizes of the proppants 70 and compressible, three-dimensional anti-settling agents 60 relative to the fracture 62 have been exaggerated for illustrative purposes and are not to scale. The method and composition is a success because the permeability of the closed fracture 62 of FIG. 5B would be greatly improved as compared with upper fracture 18 as shown in FIG. 1B as almost completely closed or collapsed.

However, in an optional embodiment, over time and/or temperature, optional hydrolyzable portions of agents 60 dissolve and hydrolyze to further improve the permeability of the proppant pack within fracture 62. Nevertheless, by this time fracture 62 has closed and the proppants 70 are permanently in place and agents 60 are likely no longer needed. Indeed, in one non-limiting embodiment, all of agents 60 may be hydrolyzed to further improve the permeability of the proppant pack. However, even if not all of the agents 60 are hydrolyzed or dissolved, it will be appreciated that permeability will be improved. Depending on the situation, and how precisely and over what period of time the agents 60 and proppants 70 may be placed in fracture 62, it may be desirable in some non-limiting embodiments for some agents 60 to remain even after other agents or some components of agents 60 have been partially or completely hydrolyzed, to be sure that the proppants are inhibited or prevented from settling prior to fracture 62 closing. Alternatively, different components of agents 60 may be hydrolyzable, but at different rates.

In the foregoing specification, the invention has been described with reference to specific embodiments thereof, and has been described as effective in providing methods and compositions for using compressible, three-dimensional anti-settling agent to inhibit or prevent the settling of proppants in fractures. However, it will be evident that various modifications and changes can be made thereto without departing from the broader scope of the invention as set forth in the appended claims. Accordingly, the specification is to be regarded in an illustrative rather than a restrictive sense. For example, specific combinations of anti-settling agents; components; fabrics; filaments; threads; polymers; laminations; layers; barbs; functional structures; proppants; treatment, fracturing and other carrier fluids; brines; acids; dimensions; proportions; aspect ratios; materials; and other components falling within the claimed elements and parameters, but not specifically identified or tried in a particular method or composition, are anticipated to be within the scope of this invention. Similarly, it is expected that the methods may be successfully practiced using different sequences, loadings, pHs, compositions, structures, temperature ranges, and proportions than those described or exemplified herein.

The present invention may suitably comprise, consist of or consist essentially of the elements disclosed and may be practiced in the absence of an element not disclosed. For instance, there may be provided a method of suspending proppants in a hydraulic fracture of a subterranean formation, where the method comprises, consists of, or consists essentially of hydraulically fracturing the subterranean formation to form fractures in the formation; introducing proppants into the fractures; during and/or after hydraulically fracturing the subterranean formation, introducing a plurality of compressible, three-dimensional anti-settling agents into the fractures, comprising, consisting of, or consisting essentially of at least partially compressing the compressible, three-dimensional anti-settling agents during the introducing, expanding the at least partially compressed compressible, three-dimensional anti-settling agents, and contacting and inhibiting or preventing the proppant from settling by gravity within the fractures.

In another non-limiting embodiment, there may be provided a fluid for suspending proppants in a hydraulic fracture of a subterranean formation, the fluid consisting essentially of or consisting of a carrier fluid; a plurality of compressible, three-dimensional anti-settling agents; and a plurality of proppants.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method of suspending proppants in a hydraulic fracture of a subterranean formation, the method comprising:
hydraulically fracturing the subterranean formation to form fractures in the formation;
introducing proppants into the fractures;
introducing a plurality of compressible, three-dimensional anti-settling agents into the fractures where the compressible, three-dimensional anti-settling agents are at least partially compressed;
at least partially expanding the at least partially compressed compressible, three-dimensional anti-settling agents; and
contacting and inhibiting or preventing the proppant from settling at the bottom of the fractures; and
closing the fractures against the proppants.

2. The method of claim 1 where the compressible, three-dimensional anti-settling agents comprise a plurality of filaments connected by a structure selected from the group consisting of:
woven,
non-woven,
knitted,
laminated,
plied,
spun,
knotted,
stacked, and
combinations thereof.

3. The method of claim 1 where the fractures each have at least two opposing fracture walls across a gap and where:
the expanded compressible, three-dimensional anti-settling agents singly have at least one dimension that spans the gap between the opposing fracture walls; or
multiple expanded compressible, three-dimensional anti-settling agents interconnected with one another spans the gap between the opposing fracture walls.

4. The method of claim 1 where the compressible, three-dimensional anti-settling agents comprise a material selected from the group consisting of cotton, wool, silk, fiberglass, polyester, polyurethane, aramid, acrylic, nylon, polyethylene, polypropylene, polyamide, cellulose, polylactide, polyethylene terephthalate, rayon, metal foams, ceramic foams, polyvinyl alcohol, and combinations thereof.

5. The method of claim 1 where the compressible, three-dimensional anti-settling agents comprise when not compressed:
an average length of from about 0.5 mm to about 51 mm;
an average width of from about 0.02 mm to about 0.5 mm; and
an average thickness of from about 8 mm to about 50 mm.

6. The method of claim 1 where introducing the compressible, three-dimensional anti-settling agents into the fractures comprises a carrier fluid where a proportion of compressible, three-dimensional anti-settling agents in the carrier fluid ranges from about 0.1 pptg to about 200 pptg (about 0.01 to about 24 kg/m³).

7. The method of claim 1 where introducing the compressible, three-dimensional anti-settling agents into the fractures comprises a carrier fluid where the carrier fluid has a density of from about 15 pptg to about 60 pptg (about 1.8 to about 7.2 kg/m³).

8. The method of claim 1 where the compressible, three-dimensional anti-settling agents have a plurality of barbs extending therefrom.

9. The method of claim 1 where the compressible, three-dimensional anti-settling agents comprise a plurality of filaments in the range of 50 to 2 per square inch (7.8 to 0.3 per cm²).

10. The method of claim 1 where the proppants and the compressible, three-dimensional anti-settling agents are introduced into the fractures at approximately the same time.

11. A method of suspending proppants in a hydraulic fracture of a subterranean formation, the method comprising:
hydraulically fracturing the subterranean formation to form fractures in the formation;
introducing proppants into the fractures;
introducing a plurality of compressible, three-dimensional anti-settling agents into the fractures where the compressible, three-dimensional anti-settling agents are at least partially compressed, where this introducing comprises a carrier fluid where a proportion of compressible, three-dimensional anti-settling agents in the carrier fluid ranges from about 0.1 pptg to about 200 pptg (about 0.01 to about 24 kg/m³);
at least partially expanding the at least partially compressed compressible, three-dimensional anti-settling agents; and
contacting and inhibiting or preventing the proppant from settling at the bottom of the fractures; and
closing the fractures against the proppants;
where the compressible, three-dimensional anti-settling agents comprise when not compressed:
an average length of from about 0.5 mm to about 51 mm;
an average width of from about 0.02 mm to about 0.5 mm; and
an average thickness of from about 8 mm to about 50 mm.

12. The method of claim 11 where the compressible, three-dimensional anti-settling agents comprise a plurality of filaments connected by a structure selected from the group consisting of:
woven,
non-woven,
knitted,
laminated,
plied,
spun,
knotted,
stacked, and
combinations thereof.

13. A fluid for suspending proppants in a hydraulic fracture of a subterranean formation, the fluid comprising:
a carrier fluid,
a plurality of compressible, three-dimensional anti-settling agents, and
a plurality of proppants.

14. The fluid of claim 13 where the compressible, three-dimensional anti-settling agents comprise a plurality of filaments connected by a structure selected from the group consisting of:
woven,
non-woven,
knitted,
laminated,
plied,
spun,
knotted,
stacked, and
combinations thereof.

15. The fluid of claim 13 where the compressible, three-dimensional anti-settling agents comprise a material selected from the group consisting of cotton, wool, silk, fiberglass, polyester, polyurethane, aramid, acrylic, nylon, polyethylene, polypropylene, polyamide, cellulose, polylactide, polyethylene terephthalate, rayon, metal foams, ceramic foams, polyvinyl alcohol and combinations thereof.

16. The fluid of claim 13 where the compressible, three-dimensional anti-settling agents comprise when not compressed:
an average length of from about 0.5 mm to about 51 mm;
an average width of from about 0.02 mm to about 0.5 mm; and
an average thickness of from about 8 mm to about 50 mm.

17. The fluid of claim 13 where a proportion of compressible, three-dimensional anti-settling agents in the carrier fluid ranges from about 0.1 pptg to about 200 pptg (about 0.01 to about 24 kg/m³).

18. The fluid of claim 13 where the carrier fluid has a density of from about 15 pptg to about 60 pptg (about 1.8 to about 7.2 kg/m³).

19. The fluid of claim 13 where the compressible, three-dimensional anti-settling agents have a plurality of barbs extending therefrom.

20. The fluid of claim 13 where the compressible, three-dimensional anti-settling agents comprise a plurality of filaments in the range of 50 to 2 per square inch (7.8 to 0.3 per cm²).
